(19) United States
(12) Patent Application Publication
(10) Pub. No.: US 2026/0217398 A1
(43) Pub. Date: Jul. 30, 2026

(54) APPARATUS AND METHOD FOR AUTOMATICALLY CLOSING CONTAINERS

(71) Applicant: I.M.A. INDUSTRIA MACCHINE AUTOMATICHE S.P.A., OZZANO DELL'EMILIA (BO) (IT) (IT)

(72) Inventors: Claudio TREBBI, OZZANO DELL'EMILIA (BO) (IT) (IT); Alessandro FARNE, OZZANO DELL'EMILIA (BO) (IT) (IT); Gianluca ZAULI, OZZANO DELL'EMILIA (BO) (IT) (IT); Daniele RICCIARDI, OZZANO DELL'EMILIA (BO) (IT) (IT); Filippo MEARINI, OZZANO DELL'EMILIA (BO) (IT) (IT); Sergio MANERA, OZZANO DELL'EMILIA (BO) (IT) (IT); Annalisa MALFATTO, OZZANO DELL'EMILIA (BO) (IT) (IT)

(21) Appl. No.: 19/143,054

(22) PCT Filed: Dec. 13, 2023
(86) PCT No.: PCT/IT2023/050279

§ 371 Date: Jun. 25, 2025

(30) Foreign Application Priority Data
Dec. 28, 2022 (IT) 102022000026916

(51) Int. Cl. B65B 7/28; B65B 7/16; B65G 54/02

(52) U.S. Cl. CPC B65B 7/285; B65B 7/161; B65G 54/02

(57) ABSTRACT

An apparatus and method for automatically closing one or more containers includes a base plate and one or more transport members having their own respective magnetic elements. Each configured transport members supports a container or possibly a crimping device, and moves in a coordinated manner with respect to the base plate through the energization of suitable electric elements.

### FIELD OF THE INVENTION

The present invention concerns an apparatus and a method for automatically closing, or capping, containers, in particular ones of small sizes, for example vials, flasks or phials, which are filled with fluid, solid, powder, or gel products, using closure elements, such as caps, crimp caps, ring seal caps or suchlike. By way of a non-limiting example, the apparatus and method according to the present invention can find application in the pharmaceutical, cosmetic, healthcare, chemical and/or food fields, or sectors, for example as an integral part of a more complex machine for the automatic packaging of the aforementioned products.

### BACKGROUND OF THE INVENTION

Several methods and apparatuses are known in the pharmaceutical, cosmetic, healthcare, chemical and/or food sectors for automatically packaging products inside containers, for example, but not only, ones of small sizes, such as vials, flasks, phials or suchlike, which provide to use planar motors, which are well known to the people of skill in the art.

In these sectors, there is an increasing demand for apparatuses and methods that can package the products in an environment that is safe and aseptic, ecologically sustainable and silent, without generating pollutants and agents that could contaminate the products and their containers, and in which human intervention to carry out the various packaging operations is reduced to a minimum, if not actually eliminated.

In recent years the same Applicant has designed and developed different methods and automatic apparatuses that provide to use planar motors, so much so that some new and original technical solutions have been protected by filing several patent applications, some of which have been published, for example international patent applications WO 2020/240601, WO 2021/001863, WO 2021/014476 and WO 2022/201207.

Another solution known in the art is described by US 2017/0225814 A1, in which it is provided to employ planar motors to move a plurality of containers toward a filling station.

It is known that planar motors comprise magnetic means, for example permanent magnets, which cooperate with electric energizing means operatively associated with them and configured to selectively generate one or more magnetic fields to affect the magnetic means. In some embodiments, the magnetic means as above are mounted on a transport member, known to the people of skill in the art as “mover”, while the electric energizing means, for example comprising coils, are incorporated within a base plate having a fixed driving surface, with respect to which the transport member can move, advantageously without contacting it, thanks to the controlled electromagnetic field which is selectively generated between the magnetic means and the electric energizing means. Usually, each transport member can move independently of the others with respect to the fixed driving surface, maintaining a distance from the latter of the order of a few millimeters, for example from 1 to 4 mm, with even high speeds, of the order of a few meters per second, for example 4 m/s, with considerable accelerations, even greater than G or 2 G, and with a positioning accuracy of a few microns. In addition, the planar motors currently available on the market are very versatile and allow to follow the most varied trajectories and paths, not only straight, or curved, and not only horizontal, with respect to the driving surface, by suitably commanding the electric energizing means, for example using even complex software available on the market.

However, known apparatuses and methods do not provide to use the planar motors to also carry out the “capping” step, understood as covering a container by means of a suitable closing unit, such as a cap, or a lid, and a possible subsequent “crimping” step, understood as laying a safety crimp cap, for example made of metal, on the container. In fact, until now, in the prior art, rotary electric motors have always been used for these steps, usually combined with mechanical advancing mechanisms, with the disadvantages inherent in the use of such motors/mechanical mechanisms in a sterilized environment, such as that of the aforementioned pharmaceutical, cosmetic, healthcare, chemical and/or food sectors.

There is therefore the need to provide an apparatus and develop a method for automatically closing containers, and thus complete the packaging of products, especially very delicate ones, for example in the pharmaceutical, cosmetic, healthcare, chemical and/or food sectors, which can overcome at least the aforementioned disadvantage that exists in the state of the art.

To do this, it is necessary to solve the technical problem of creating an apparatus and developing a method for automatically closing containers, in which all the work steps are carried out without the risk of producing and dispersing in the work environment, even in minimum quantities, particles and/or dusts that may contaminate the product contained in the containers and the containers themselves.

In particular, one purpose of the present invention is to provide an apparatus and develop a method for automatically closing and sealing containers which are safe and guarantee hygiene and cleanliness standards that make them suitable to also be used in machines for the pharmaceutical, cosmetic, healthcare, chemical and/or food sectors which, as required by the regulations in force in most states, require an aseptic and contaminant-free work environment.

Another purpose of the present invention is to provide an apparatus and to develop a method for automatically closing and sealing containers which are reliable and highly efficient, and which allow to have high productivity, for example of the order of several tens of thousands of closing operations, including a perfect crimping, per hour.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the technical problem disclosed above in a new and original way, also achieving considerable advantages compared to the state of the prior art, an apparatus according to the present invention for automatically closing a container with a closing unit comprises a base plate having a driving surface and a first transport member onto which the container is placed, wherein the transport member is positionable and movable on the driving surface by means of a magnetic coupling between the rotor magnetic field generated by magnetic means of the first transport member and the stator magnetic fields generated by electric means belonging to the base plate, so that a selective energization of the electric means allows a movement of the first transport member relative to the driving surface.

The closing unit comprises both a cap and also a crimp cap having the shape of a cylindrical cover configured to contain the cap inside it, and having the function of sealing and making hermetic the closure of the container.

The apparatus also comprises a crimping device configured to crimp the crimp cap.

The expression “crimp” refers to the operation of clamping the crimp cap on the container, during which it is provided to mechanically deform the crimp cap in order to attach it to the container.

In accordance with another aspect of the present invention, at least one between the crimping device and the first transport member is configured to be selectively:
moved closer to each other to bring the crimp cap coupled with the container placed on the first transport member, until a crimping element of the crimping device contacts the crimp cap,
   and
rotated to allow the crimping device to crimp the crimp cap all around an annular shoulder of the container.

In accordance with another aspect of the present invention, the apparatus further comprises a control unit configured to selectively control the energization of the electric means to allow the movements of the first transport member, or to possibly block it selectively against the driving surface.

In accordance with another aspect of the present invention, the crimping device is mounted on a second transport member which is movable on the driving surface and comprises further magnetic means configured to interact with the electric means.

In accordance with another aspect of the present invention, the control unit is also configured to selectively control the energization of the electric means to allow the movements of the second transport member.

In accordance with another aspect of the present invention, the crimping element comprises at least one blade or one or more disks.

In accordance with another aspect of the present invention, the crimping element is mounted fixed or rotatable on an arm, in particular the blade is preferably mounted fixed, and the one or more disks are mounted rotatable on the arm.

In accordance with another aspect of the present invention, the arm is configured to be movable to adjust the distance of the crimping element relative to the driving surface.

In accordance with another aspect of the present invention, the arm is joined to two levers which are in turn mounted on two respective second transport members.

In accordance with another aspect of the present invention, the first transport member and/or the crimping device are/is configured to be selectively moved in a vertical direction perpendicular to the driving surface during crimping of the crimp cap on the annular shoulder of the container.

In accordance with another aspect of the present invention, the apparatus comprises a closing zone in which the crimping device interacts with the container to crimp the crimp cap. In particular, a first axis is defined in the closing zone, perpendicular to the driving surface, to which the cap, crimp cap and container are coaxial at least during the crimping step.

In accordance with another aspect of the present invention, the apparatus comprises a pushing member configured to push the crimp cap against the container and keep the container in a stable position.

In accordance with another aspect of the present invention, the pushing member is placed in the closing zone and coaxial to said first axis.

In accordance with another aspect of the present invention, the first transport member comprises a containing member provided with a seating in which the container can be tightly inserted.

In accordance with another aspect of the present invention, the seating has a central axis parallel to said first axis.

In accordance with another aspect of the present invention, a method for automatically closing a container with a closing unit using an apparatus having a base plate having a driving surface, and a first transport member onto which the container is placed, wherein the transport member is positionable and movable on the driving surface by means of a magnetic coupling between the rotor magnetic field generated by magnetic means of the first transport member and the stator magnetic fields generated by electric means belonging to the base plate, so that a selective energization of the electric means allows a movement of the first transport member relative to the driving surface. The apparatus also comprises a crimping device configured to crimp the crimp cap.

In accordance with another aspect of the present invention, the method provides that at least one between the crimping device and the first transport member is configured to be selectively:
moved closer to each other to bring the crimp cap coupled with the container placed on the first transport member, until a crimping element of the crimping device contacts the crimp cap,
   and
rotated to allow the crimping device to crimp the crimp cap all around an annular shoulder of the container.

In accordance with another aspect of the present invention, a capping step is provided in which a cap is inserted on the container from above.

In accordance with another aspect of the present invention, a subsequent crimping step is also provided, in which first a crimp cap is placed so as to cover the cap, and then a lower part of the same crimp cap is mechanically deformed against an annular shoulder of the container.

In accordance with another aspect of the present invention, the first transport member is moved on the driving surface, or blocked on the driving surface, during the crimping step.

In accordance with another aspect of the present invention, the crimping device is mounted on a second transport member which is moved on the driving surface during the crimping step and comprises further magnetic means configured to interact with the electric means.

In accordance with another aspect of the present invention, the first transport member and/or the crimping device is selectively moved in a vertical direction perpendicular to the driving surface during the crimping step.

In accordance with another aspect of the present invention, a pushing member pushes the crimp cap against the container placed on the first transport member and keeps the container in a stable position during the crimping step.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a lateral, schematic and partly sectioned view of a generic apparatus according to the present invention for automatically closing a container, in accordance with a first embodiment, with some parts shown spaced apart from each other, for a better understanding of the apparatus itself and its operation;

FIG. 2 is a lateral, schematic and enlarged scale view of an example of a container that can be closed automatically by the apparatus according to the present invention;

FIG. 3 is a schematic top view of an apparatus according to the present invention, in accordance with a second embodiment;

FIG. 4 is a perspective and schematic view of an apparatus according to the present invention, for automatically closing a container, in accordance with a third embodiment;

FIG. 5 is a perspective and schematic view of an apparatus according to the present invention, for automatically closing a container, in accordance with a fourth embodiment;

FIG. 6 is a top view of the apparatus of FIG. 5;

FIG. 7 is a lateral, schematic and partly sectioned view of the apparatus of FIG. 5, with some parts shown spaced apart from each other, as in FIG. 1; and

FIG. 8 is a view similar to that of FIG. 7, but with the same parts shown in a position of closure of the container of FIG. 2.

We must clarify that the phraseology and terminology used in the present description, as well as the figures in the attached drawings also in relation as to how described, have the sole function of better illustrating and explaining the present invention, their purpose being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

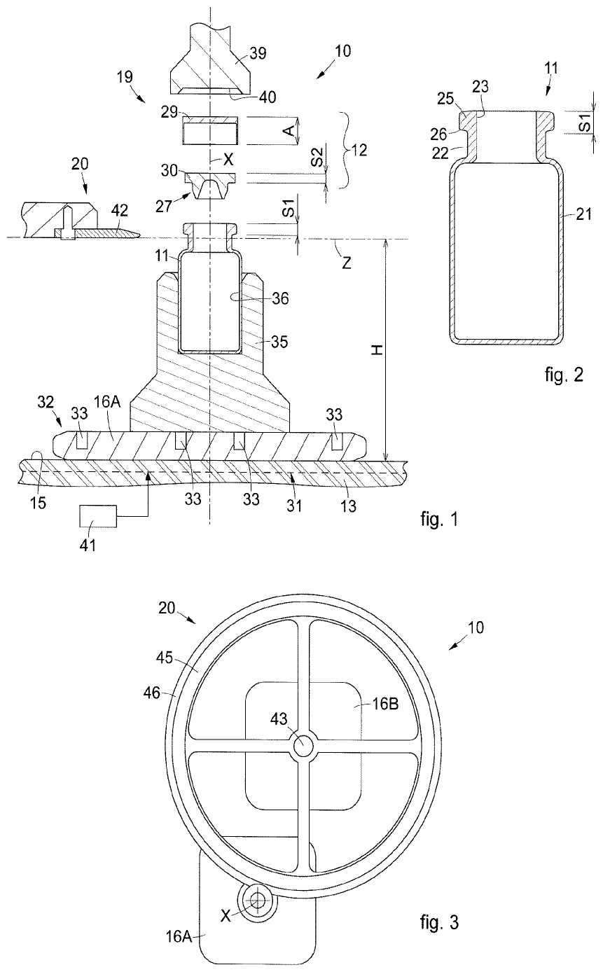

With reference to the drawings, an apparatus 10 according to the present invention for automatically closing a container 11 with a closing unit 12 comprises, as components common to all embodiments: a base plate 13 having a driving surface 15, advantageously fixed and for example horizontal; and a first transport member 16A (FIGS. 1 and from 3 to 8), or mover, configured to move relative to the driving surface 15 to support a respective container 11.

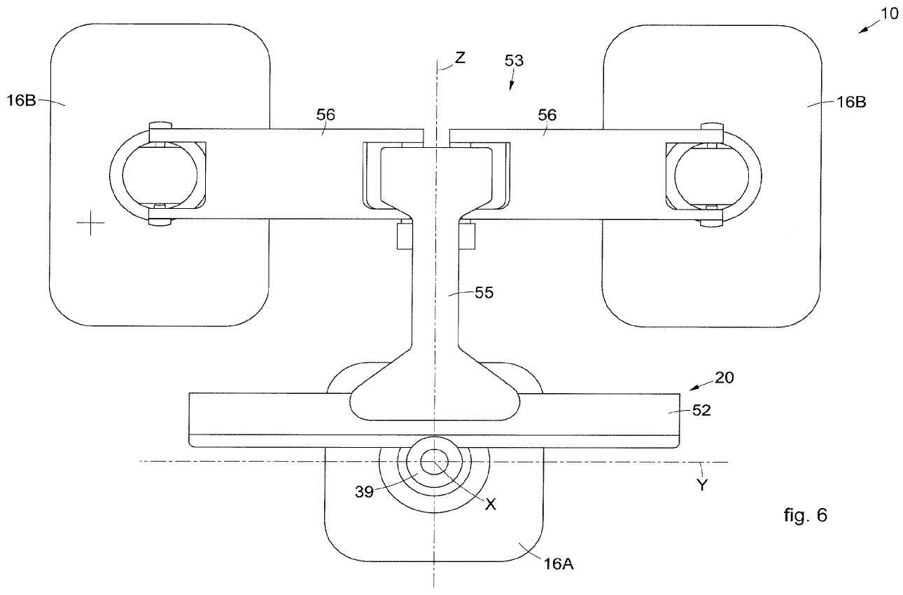

In the attached drawings, a first axis X, perpendicular to the reference surface 15, a second axis Y (FIGS. 5 and 6) perpendicular to the first axis X, and a third axis Z (FIGS. from 5 to 8) perpendicular to both the first axis X and also the second axis Y, are indicated with a line formed by dashes and dots, the axes X, Y and Z being oriented so as to form a set of three Cartesian axes.

In further embodiments, the apparatus comprises a plurality of first support members 16A, each configured to support a respective container 11.

In some embodiments of the present invention (FIGS. from 3 to 8), the apparatus also comprises second transport members 16B, similar to the first transport members 16A and configured to support a crimping device 20, which will be described in detail below.

The containers 11 (FIG. 2) can be of any type whatsoever, in particular of small sizes, such as vials, flasks, phials, or suchlike, commonly used in the pharmaceutical, cosmetic, healthcare, chemical and/or food sectors and suitable to be filled with the most diverse products, which can be fluids, solids, in powder form, or gels. By way of example, each container 11 comprises an internally hollow body 21, a neck 22 provided with a central hole 23 and, at the upper end of the neck 22, a ring 25, or annular protrusion, having a thickness S1, for example of a few millimeters. In its lower part the ring 25 defines an annular shoulder 26, also for example of a few millimeters, which can be perpendicular to the central axis of the container 11, or slightly inclined downward and/or radiused to the cylindrical wall of the neck 22.

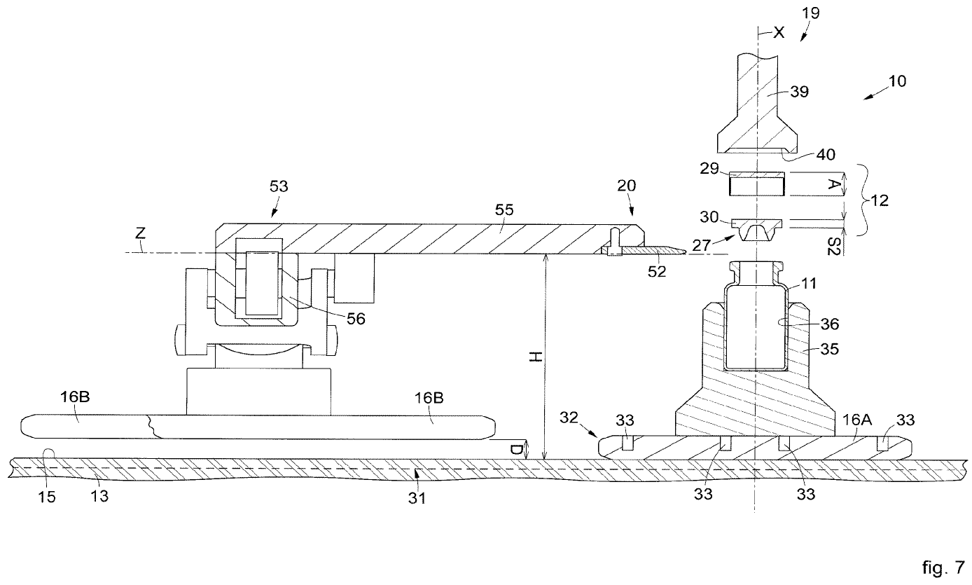

In the example given here, each closing unit 12 comprises both a cap 27 (FIG. 1) and also a crimp cap 29. For example, the cap 27 can be made of plastic material and suitable to be inserted precisely into the central hole 23 in order to cap the container 11, after the product to be packaged has been properly inserted in it. The cap 27 can advantageously comprise an upper part 30 having an external diameter substantially equal to that of the ring 25 and a thickness S2, also of a few millimeters for example. The crimp cap 29 can be metallic, for example in aluminum, it has the shape of a cylindrical cover configured to contain the cap 27 inside it and has the function of sealing and making hermetic the closure of the container 11. The height A (FIGS. 1 and 7) of the crimp cap 29 is substantially equal to, or slightly less than, the sum of the thickness S1 of the ring 25, the thickness S2 of the upper part 30 and of the annular shoulder 26.

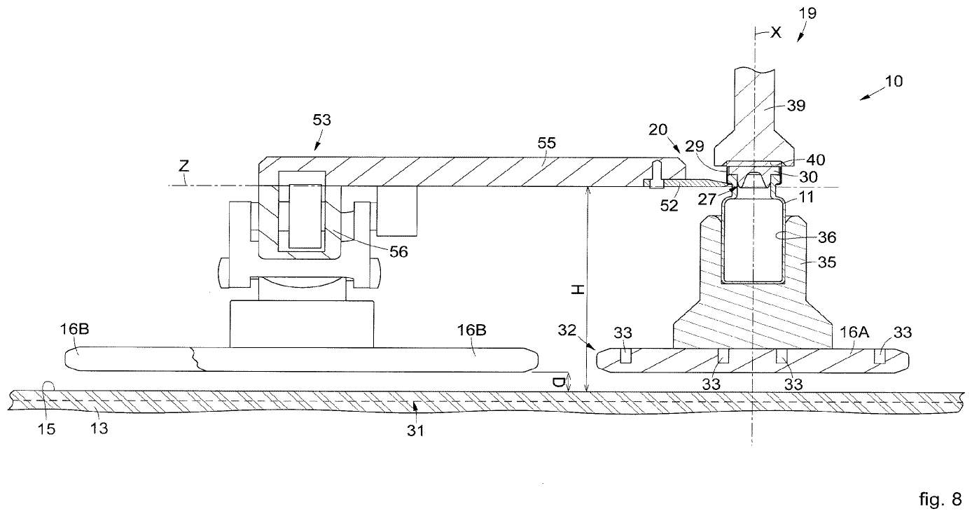

Other components common to all embodiments of the present invention are electric means 31 (FIGS. 1 and from 6 to 8), for example consisting of or comprising coils of a known type and not shown in the drawings, which are associated with, or present in, the base plate 13 and selectively energizable in order to generate one or more magnetic fields at least above the driving surface 15. Moreover, each of the first and second transport members 16A, 16B is provided with magnetic means 32, for example consisting of or comprising magnets 33, for example permanent, of a known type, configured to interact with the aforementioned one or more magnetic fields, so that the selective energization of the electric means 31 allows the movement, understood as linear movement and/or rotation, even micrometric, of one or more of the transport members relative to the driving surface 15, without contacting it. During such movement, the transport members 16A, 16B are kept at a distance D (FIGS. 7 and 8) from the driving surface 15, which varies between a few tenths of a millimeter and a few millimeters.

In other words, the electric means 31 and the magnetic means 32 constitute actual planar motors. The inventive idea is in fact to use the latter in the apparatus 10 according to the present invention to carry out the capping and crimping of the containers 11.

Further elements common to all embodiments of the present invention are the following.

Each first transport member 16A comprises a containing member 35 (FIGS. 1, 7 and 8), in the form of a glass, or cup, also known to the people of skill in the art by the French term “godet”, provided with a seating 36 having a central axis parallel to the first axis X and consisting, for example, of a blind cavity, in which the body 21 of a container 11 can be inserted precisely, or with a slight clearance.

The apparatus 10 comprises a pushing, or contrast, member 39, preferably parallel to, or coinciding with, the first axis X and having a hollow lower seating 40 configured to accommodate the upper part of the crimp cap 29. The pushing member 39 can be placed in a fixed position relative to the driving surface 15, or be movable relative thereto, in the capping and crimping steps, for example only axially relative to a corresponding first transport member 16A, or also together with the latter parallel to the second axis Y and/or to the third axis Z, or with a combination thereof, as will be described in detail below.

Furthermore, the apparatus 10 comprises a control unit 41 (FIG. 1), for example of the electronic and programmable type, configured to selectively energize the electric means 31 and possibly also command the actuation of the pushing member 39.

Some embodiments of the present invention can provide that the pushing member 39 is motorized, in a known manner, to make it selectively rotate around the first axis X, under the control of the control unit 41. In this case, optionally, a flanged bearing can be provided on the bottom of the seating 36 of the containing member 35, of a known type and not shown in the drawings, which allows the container 11 to rotate around the first axis X in order to follow the possible rotation of the pushing member 39.

The apparatus 10 according to the present invention can be part of a more complex machine, of a known type or one which will be developed in the future, for the automated packaging of products into the containers 11.

In accordance with a first embodiment of the apparatus 10, very simplified, schematically shown in FIG. 1, the crimping device 20 comprises a fixed blade 42, having for example a rectilinear profile, substantially parallel to the driving surface 15 and placed at a certain distance H therefrom.

In this case, the operation of the apparatus 10, which corresponds to one of the methods for closing containers 11 according to the present invention, that is, for capping and crimping them, comprises the following steps, coordinated and commanded by the control unit 41:
a preparation step in which the cap 27 and the crimp cap 29 are positioned coaxial to the pushing member 39 in the closing zone 19, with the crimp cap 29 on top of the cap 27; this preparation step can take place in any manner known to the people of skill in the art and therefore is not described in detail;
a capping step in which the pushing member 39 is actuated, for example to be lowered, and the electric means 31 are possibly energized, or de-energized, in a suitable manner so that the first transport member 16A is kept stationary against the driving surface 15 to better counteract the action of the pushing member 39 toward the base plate 13, and this to cause the cap 27 to enter the central hole 23 of the container 11 until the upper part 30 of the cap 27 comes into contact with the ring 25, and at the same time the crimp cap 29 covers the cap 27 and protrudes with its lower part, still in a vertical position, below the annular shoulder 26; and
a crimping step in which the electric means 31 are energized so that the first transport member 16A, with on board the container 11 just capped with the cap 27 and provided with the crimp cap 29, is gradually brought against the blade 42 with a movement parallel to the third axis Z, possibly alternating, that is, moving closer to and away from the blade 42, and a simultaneous rotation around the first axis X, so that after one or more complete revolutions, for example three, that is, so as to describe a regular spiral starting from the periphery of the crimp cap 29 toward the central axis of the container 11, the lower part of the crimp cap 29 is completely folded against the annular shoulder 26 of the ring 25; possibly, if the profile of the annular shoulder 26 is inclined and/or radiused, the electric means 31 are energized so as to make the first transport member 16A also perform an axial movement, that is, parallel to the first axis X, in order to precisely follow this profile. In other words, the spiral-shaped trajectory may not only be described on one plane, but may advantageously also go down, or up, to follow the profile of the annular shoulder 26. As an alternative to the rotation of the first transport member 16A around the first axis X, it is also possible to provide the rotation of the pushing member 39 to make the container 11 rotate relative to the containing member 35, or a combination of the two rotary movements of the first transport member 16A and the pushing member 39.

At the end of the crimping step, the electric means 31 are energized so that the first transport member 16A containing the container 11 already capped and sealed with the crimp cap 29 is moved toward a subsequent work station, so that another first transport member 16A containing another container 11 can be brought into position to repeat the operations described above.

The cycle time to complete a closing operation of the container 11, including its capping and crimping, is very short, of the order of tenths of a second, so the productivity of the apparatus 10 according to the present invention is very high, of the order of several thousand operations per hour.

The preparation and capping steps as above are also common for the other embodiments of the present invention that are described below.

In accordance with a second embodiment of the apparatus 10, shown schematically in FIG. 3, the crimping device 20, instead of the fixed blade 42, comprises a second transport member 16B on which a pin 43 is mounted, on which a wheel 45 is free to rotate peripherally having a circular blade 46 configured to fold the lower part of the crimp cap 29 toward the annular shoulder 26. The central axis of the pin 43, and therefore of the wheel 45, is parallel to the first axis X.

In this second embodiment, the crimping step provides that the electric means 31 are energized so that the first transport member 16A, with on board the container 11 just capped with the cap 27 and provided with the crimp cap 29, is kept stationary against the driving surface 15, and that, simultaneously, the second transport member 16B is made to rotate around the first transport member 16A, that is, around the first axis X. We must clarify that, in order to do this, the external diameter of the circular blade 46 has to be sufficiently large so that there is no interference between the second transport member 16B, which moves, and the first transport member 16A, which remains stationary, and which keeps the already capped container 11 and the crimp cap 29 coaxial to the first axis X.

In particular, the electric means 31 are energized so that, while the second transport member 16B rotates around the first transport member 16A, the circular blade 46 gradually moves closer to the latter, thus describing a spiral-shaped trajectory, for example with three full revolutions, gradually moving increasingly alongside the container 11, until the same circular blade 46 manages to completely rivet the crimp cap 29 against the annular shoulder 26, in a manner similar to what described above for the first embodiment.

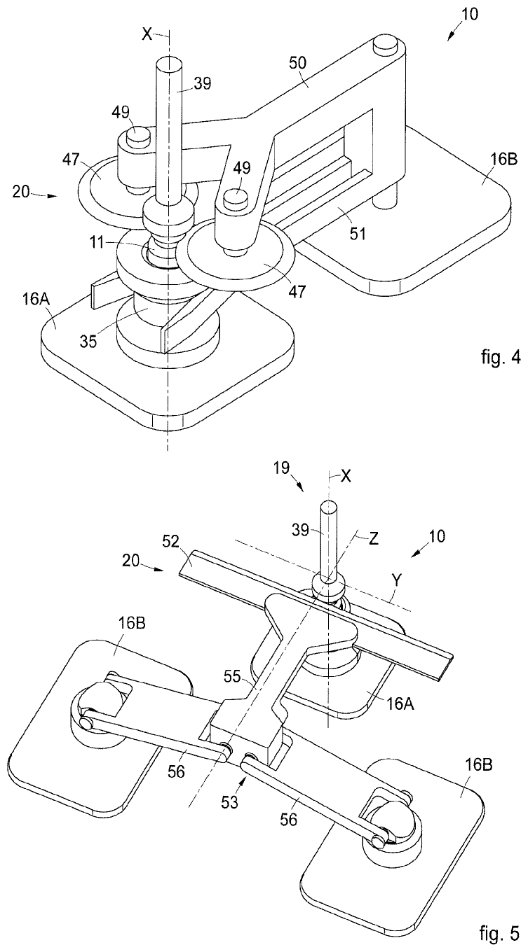

In accordance with a third embodiment of the apparatus 10, shown schematically in FIG. 4 and in many respects similar to the second embodiment described above, the crimping device 20, instead of comprising the single wheel 45, comprises two identical disks 47 coplanar with each other, as well as parallel to the driving surface 15. Each disc 47 is mounted freely rotatable around its own pin 49 supported at the end of an arm 50 mounted on a second transport member 16B. The external diameter of the two discs 47 and their center distance is chosen so that they simultaneously contact the crimp cap 29 in two points of the latter which are diametrically opposite, or almost.

Furthermore, a guide fork 51 configured to contact the containing member 35 containing the container 11 can optionally be provided below, and parallel to, the arm 50. This has the advantage of greatly reducing the overall size and weight of the part mounted on the second transport member 16B.

The operation of the apparatus 10 in accordance with the third embodiment, in particular the crimping step, is similar to that of the second embodiment described above, with the difference that since there are the two discs 47 in contact with the crimp cap 29, this allows to have a shorter cycle time to complete the one or more rotations, for example three, around the crimp cap 29, which are required to carry out a perfectly executed crimping.

In accordance with a fourth embodiment of the apparatus 10, shown schematically in FIGS. from 5 to 8, the crimping device 20 comprises a single rectilinear blade 52, which has the same function as the blade 42 but, instead of being fixed, is mounted on adjustment means 53 configured to selectively adjust the distance H (FIG. 7) of the same rectilinear blade 52 from the driving surface 15.

The adjustment means 53 comprise an arm 55 (FIGS. from 5 to 8) which is parallel to the driving surface 15, has one end on which the rectilinear blade 52 is attached and an opposite end articulated on two identical levers 56, each pivoted at their base on a second transport member 16B, thus forming a toggle mechanism.

In the fourth embodiment shown here, the length of the rectilinear blade 52 is at least equal to a multiple of the external circumference of the crimp cap 29, wherein advantageously this integral multiple is three, in order to carry out a spiral-shaped crimping with three concentric revolutions.

The operation of the apparatus 10 according to the fourth embodiment, in particular the crimping step, provides a first sub-step in which the electric means 31 are energized so that the two second transport members 16B move closer to or away from each other so that the rectilinear blade 52, thanks to the articulation formed by the levers 56 with the arm 55, is brought to the desired distance H from the driving surface 15; this distance H can be changed initially as a function of the sizes of the container 11 to be closed, or even during the crimping step, in particular to follow the profile of the annular shoulder 26 as described above for the other embodiments.

The crimping step also comprises a second sub-step, which can be carried out in one of the following three manners:
a) in accordance with a first manner, the crimping is performed by energizing the electric means 31 so that the two second transport members 16B move together toward the container 11 and perform an alternating movement, back and forth, parallel to the third axis Z, mimicking the movement of a reciprocating saw, gradually touching the crimp cap 29; at the same time, the electric means 31 are energized so that the first transport member 16A moves linearly parallel to the second axis Y; during this linear movement it is not advantageous for the container 11 to remain blocked inside the containing member 35, but it is preferable that it follows with the direction of the contact and the movement of the rectilinear blade 52, rolling on the profile of the latter to thus allow a perfect crimping on the entire circumference of the crimp cap 29; in order to do this, it may be advantageous to make the pushing member 39 adequately rotate, so that the container 11 and the crimp cap 29 also rotate with it;
b) in accordance with a second manner, the crimping is performed by energizing the electric means 31 so that the first transport member 16A, with on board the container 11 just capped with the cap 27 and provided with the crimp cap 29, is gradually brought against the blade 42 with a movement parallel to the third axis Z, possibly alternating, that is, moving closer to and away from the blade 42, and is simultaneously moved linearly parallel to the second axis Y and also made to rotate around the first axis X, so that after one or more complete revolutions, for example three, that is, so as to describe a regular spiral starting from the periphery of the crimp cap 29 toward the central axis of the container 11, the lower part of the crimp cap 29 is completely folded against the annular shoulder 26 of the ring 25; also in this case, if the profile of the annular shoulder 26 is inclined and/or radiused, the electric means 31 are energized so as to make the first transport member 16A and/or the second transport members 16B also perform an axial movement parallel to the first axis X, in order to precisely follow this profile; and
c) in accordance with a third manner, the crimping is performed as provided in the first embodiment described above, that is, with the rectilinear blade 52 remaining stationary at the distance H reached in the first sub-step and with the crimp cap 29 which is made to rotate by the first transport member 16A around the first axis X; in this case, the length of the rectilinear blade 52 could even be very short.

It will be evident to the people of skill in the art that the new and original solution of using planar motors, consisting of the electric means 31 and the magnetic means 32, to carry out the automatic closure of the containers 11 brings considerable advantages in terms of reliability, productivity and cleanliness, because they do not produce any polluting agent.

It is clear that modifications and/or additions of parts or steps may be made to the closing apparatus 10 and methods as described heretofore, without departing from the field and scope of the present invention, as defined by the claims.

It is also clear that, although the present invention has been described with reference to some specific examples, a person of skill in the art will be able to achieve other equivalent forms of apparatuses and methods for automatically closing containers, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. Apparatus for automatically closing a container with a closing unit, said apparatus comprising a base plate having a driving surface, a first transport member onto which said container is placed, wherein said first transport member is positionable and movable on the driving surface by means of a magnetic coupling between a rotor magnetic field generated by magnetic means of the first transport member and stator magnetic fields generated by electric means belonging to said base plate, so that a selective energization of said electric means allows a movement of the first transport member relative to the driving surface, and a crimping device configured to crimp a crimp cap of said closing unit, wherein at least one between said crimping device and said first transport member is configured to be selectively
moved closer to each other to bring the crimp cap of said closing unit coupled with said container placed on said first transport member, until a crimping element of said crimping device contacts the crimp cap,
and
rotated to allow the crimping device to crimp the crimp cap all around an annular shoulder of the container.

2. Apparatus as in claim 1, further comprising a control unit configured to selectively control the energization of said electric means to move the first transport member on the driving surface, or to block the first transport member on said driving surface during crimping of the crimp cap on the annular shoulder of the container.

3. Apparatus as in claim 1, wherein said crimping device is mounted on a second transport member which is movable on the driving surface and comprises further magnetic means configured to interact with said electric means.

4. Apparatus as in claim 1, wherein said crimping element comprises at least one blade or one or more disks.

5. Apparatus as in claim 1, wherein said crimping element of said crimping device is mounted fixed or rotatable on an arm.

6. Apparatus as in claim 5, wherein said arm is configured to be movable to adjust a distance of the crimping element with respect to the driving surface.

7. Apparatus as in claim 5, wherein said arm is joined to two levers which are in turn mounted on two respective second transport members.

8. Apparatus as in claim 1, wherein said first transport member and/or said crimping device is configured to be selectively moved in a vertical direction perpendicular to the driving surface during crimping of the crimp cap on the annular shoulder of the container.

9. Apparatus as in claim 1, further comprising a pushing member configured to push said crimp cap against said container placed on said first transport member and keep said container in a stable position.

10. Apparatus as in claim 1, wherein said first transport member comprises a containing member provided with a seating in which said container can be tightly inserted.

11. Method for automatically closing a container with a closing unit, using an apparatus having a base plate having a driving surface, a first transport member onto which said container is placed, wherein said first transport member is positionable and movable on the driving surface by means of a magnetic coupling between a rotor magnetic field generated by magnetic means of the first transport member and stator magnetic fields generated by electric means belonging to the base plate, so that a selective energization of said electric means allows a movement of the first transport member relative to the driving surface, and a crimping device configured to crimp a crimp cap of said closing unit, wherein at least one between said crimping device and said first transport member is configured to be selectively
moved closer to each other to bring the crimp cap of said closing unit coupled with said container placed on said first transport member, until a crimping element of said crimping device contacts the crimp cap,
and
rotated to allow the crimping device to crimp the crimp cap all around an annular shoulder of the container.

12. Method as in claim 11, wherein the first transport member is moved on the driving surface, or blocked on said driving surface during the crimping step.

13. Method as in claim 11, wherein said crimping device is mounted on a second transport member which is moved on the driving surface during the crimping step and comprises further magnetic means configured to interact with said electric means.

14. Method as in claim 11, wherein said first transport member and/or said crimping device is selectively moved in a vertical direction perpendicular to the driving surface during the crimping step.

15. Method as in claim 11, wherein a pushing member pushes said crimp cap against said container placed on said first transport member and keeps said container in a stable position during the crimping step.
